(19) United States
(12) Patent Application Publication
(10) Pub. No.: US 2009/0086373 A1
(43) Pub. Date: Apr. 2, 2009

(54) DISK DRIVE WITH TURBULENCE REDUCTION PLATE

(75) Inventors: Stephen Viskochil, Los Gatos, CA (US); Joseph T. Castagna, San Jose, CA (US)

Correspondence Address: SCHWEGMAN, LUNDBERG & WOESSNER, P.A., P.O. BOX 2938, MINNEAPOLIS, MN, 55402, US

(73) Assignee: Kabushiki Kaisha Toshiba 1-1, Tokyo (JP)

(21) Appl. No.: 11/864,660

(22) Filed: Sep. 28, 2007

(51) Int. Cl. G11B 15/10

(52) U.S. Cl. 360/137

(57) ABSTRACT

A method for assembling a disk drive includes placing disks on a spindle, and pivoting a turbulence reduction plate to a position between the disks on the spindle. The turbulence reduction plate is placed on a pivot associated with the housing and then rotated into position. The turbulence reduction plate is attached to the housing and a cover is placed onto the housing to form a disk enclosure which also encloses the turbulence reduction plate.

### TECHNICAL FIELD

Various embodiments described herein relate to apparatus, systems, and methods associated with a disk drive having a turbulence reduction plate.

### BACKGROUND

A disk drive is an information storage device. A disk drive includes one or more disks clamped to a rotating spindle, and at least one head for reading information representing data from and/or writing data to the surfaces of each disk. Disk drives also include an actuator utilizing linear or rotary motion for positioning transducing head(s) over selected data tracks on the disk(s). A rotary actuator couples a slider, on which a transducing head is attached or integrally formed, to a pivot point that allows the transducing head to sweep across a surface of a rotating disk. The rotary actuator is driven by a voice coil motor. Storing data includes writing information representing data to portions of tracks on a disk. Data retrieval includes reading the information representing data from the portion of the track on which the information representing data was stored.

There is a constant competitive effort in the industry to improve various performance parameters associated with disk drives. One performance parameter manufacturers are constantly trying to increase is the speed at which information from the disk drive can be retrieved and transformed back into the data written to the drive. This is many times referred to as the access speed. One way to increase the access speed is to increase the rate a disk or disks on a spindle spins within a drive. The faster the spindle spins the disk drive, the faster the information representing data can be read off a track on the disk. Currently, spindles which carry a disk or disk drive may spin at 5400 to 7200 revolutions per minute (“RPM”). The relative motion between the disks and the housing can produce a turbulent wind within the housing at these speeds as well as at the higher speeds, which are anticipated in future drives. The turbulent wind within a disk drive can excite various components within the disk drive. Some of the components that may become excited or resonate include the disks or the actuator arm. Of course other hardware may also resonate at various frequencies. When the disk or the actuator arm or other hardware resonates or is excited, the ability to keep a transducing head over a particular track may become difficult which in turn makes it difficult to read from or write to a track reliably. This problem is exacerbated because current disk drives have a high number of tracks per inch. As a result, the width of a track is very small so even small movements due to vibrations can result in unreliable read operations and write operations.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is a perspective view of a disk drive with a cover removed before the turbulence reduction plate is placed between the disks, according to an example embodiment described herein.

FIG. 2 is a top view of a disk drive with a cover removed before the turbulence reduction plate is placed between the disks, according to an example embodiment described herein.

FIG. 3 is a perspective view of a disk drive after the turbulence reduction plate is placed between the disks, according to an example embodiment described herein.

FIG. 4 is a top view of a disk drive after the turbulence reduction plate is placed between the disks, according to an example embodiment described herein.

FIG. 5 is a perspective view of a disk drive after the turbulence reduction plate is placed between the disks and with the cover about to be installed, according to an example embodiment described herein.

FIG. 6 is a flow chart of a method for assembling a disk drive, according to an example embodiment.

FIG. 7 is a flow chart of a method for assembling a disk drive, according to an example embodiment.

FIG. 8 is a partial cross section view of the assembled disk drive, according to an example embodiment.

The description set out herein illustrates the various embodiments of the invention and such description is not intended to be construed as limiting in any manner.

### DETAILED DESCRIPTION

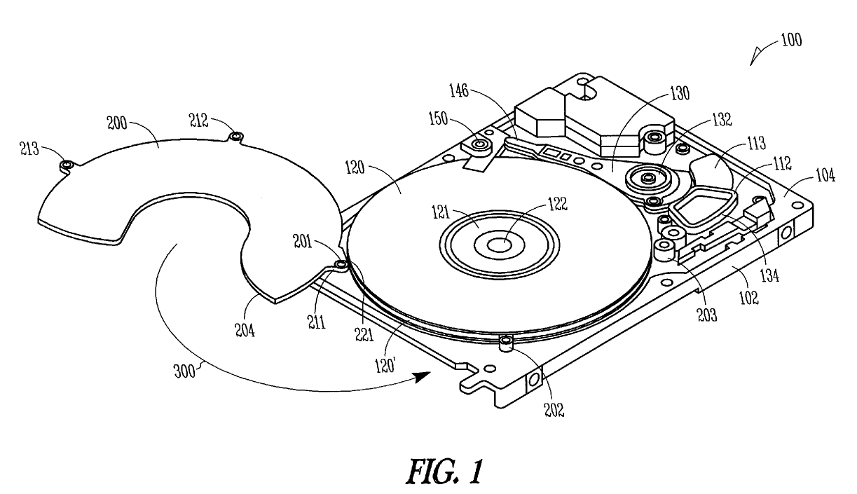

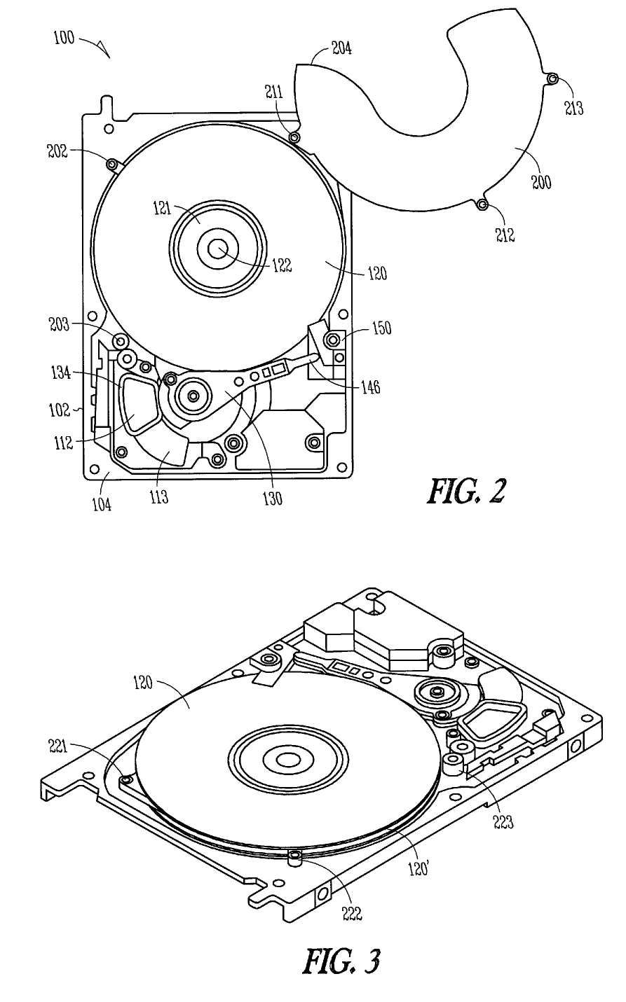

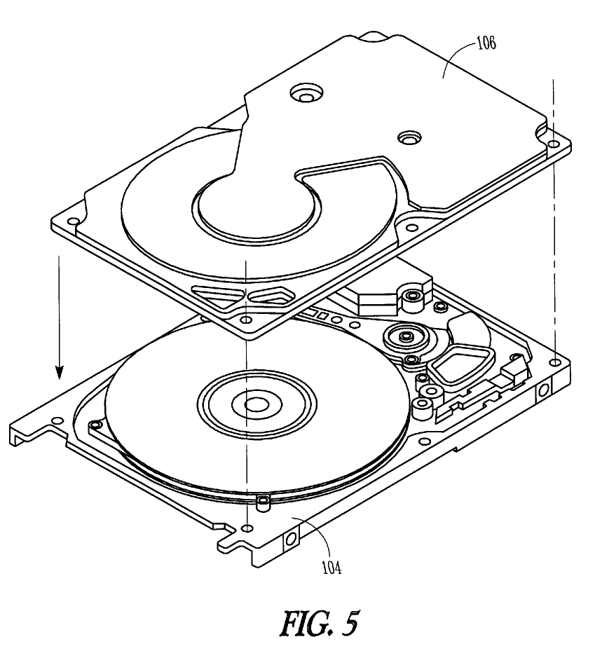

FIG. 1 is a perspective view of a disk drive 100 with a housing cover removed before a turbulence reduction plate 200 is placed between a first disk 120 and a second disk 120′, and FIG. 2 is a top view of a disk drive 100 with a cover removed before the turbulence reduction plate 200 is placed between the first disk 120 and the second disk 120′, according to an example embodiment described herein. Now referring to both FIGS. 1 and 2, the disk drive 100 will be further detailed. The disk drive 100 includes a housing 102 including a housing base 104 and a housing cover 106 (shown in FIG. 5). The housing base 104 illustrated is a base casting, but in other embodiments a housing base 104 can comprise separate components assembled prior to, or during assembly of the disk drive 100. The first disk 120 and the second disk 120′ are attached to a hub or spindle 122 that is rotated by a spindle motor. The disk 120 and the disk 120′ can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. Each of the disks 120, 120′ can be made of a light aluminum alloy, ceramic/glass or other suitable substrate, with magnetizable material deposited on one or both sides of each of the disks 120, 120′. The magnetic layer includes small domains of magnetization for storing data transferred through a transducing head 146. The transducing head 146 includes a magnetic transducer adapted to read data from and write data to the disk 120. In other embodiments, the transducing head 146 includes a separate read element and write element. For example, the separate read element can be a magneto-resistive head, also known as a MR head. It will be understood that multiple head 146 configurations can be used.

A rotary actuator 130 is pivotally mounted to the housing base 104 by a bearing 132 and sweeps an arc between an inner diameter (ID) of the disk 120 and a ramp 150 positioned near an outer diameter (OD) of the disks 120, 120′. Attached to the housing 104 is at least one magnet 113 that forms at least a portion of the stationary portion of a voice coil motor (VCM) 112. A voice coil 134 is mounted to the rotary actuator 130 and positioned in an air gap of the VCM 112. The rotary actuator 130 pivots about the bearing 132 when current is passed through the voice coil 134 and pivots in an opposite direction when the current is reversed, allowing for control of the position of the actuator 130 and the attached transducing head 146 with respect to the disk 120. The VCM 112 is coupled with a servo system that uses positioning data read by the transducing head 146 from one of the surfaces of the disks 120, 120′ to determine the position of the transducing head 146 with respect to one of a plurality of tracks on one of the disks 120, 120′. The servo system determines an appropriate current to drive through the voice coil 134, and drives the current through the voice coil 134 using a current driver and associated circuitry. It should be noted that in some transducing head includes two separate elements. One element is for reading information representing data and reading positional information or servo information. This element is known as a read element. The other element, in these embodiments, is for writing information representing data and is known as a write element. One example of such a transducing head is a magnetoresistive (MR) transducing head.

As mentioned previously, the disks 120, 120′ include a plurality of tracks on each disk surface. In an embedded type servo disk drive, the servo wedges traverse the plurality of tracks. The plurality of tracks, in some embodiments, may be arranged as a set of substantially concentric circles. Data is stored in fixed sectors along a track between the embedded servo wedges. The tracks on the disk 120, 120′ each include a plurality of data sectors. The tracks toward the inside of the disks 120, 120′ are not as long as the tracks toward the periphery of the disks 120, 120′. As a result, the tracks toward the inside of the disks 120, 120′ can not hold as many data sectors as the tracks toward the periphery of the disk 120. Tracks that are capable of holding the same number of data sectors may be grouped into x data zones. The base 104 includes several threaded mounting openings 201, 202, 203 which receive a fastener. The turbulence reduction plate 200 also includes corresponding tabs that include openings 211, 212, 213. A fastener is placed through each of the openings 211, 212, 213 and threaded into the mounting openings 201, 202, 203 in the base 104 to mount the turbulence reduction plate 200. As shown in FIG. 2, one of the base 104 or the turbulence reduction plate 200 includes a pivot pin 204. The turbulence reduction plate 200 pivots on the pivot pin 204 and is rotated in the direction of the arrow 300 shown in FIG. 1. In an alternative embodiment, a fastener 221 is placed through the opening 211 and into the opening 201. The fastener 221 is partially tightened so that the turbulence reduction plate 200 is capable of pivoting about the fastener 221. As shown in FIGS. 1 and 2, the turbulence reduction plate has not been rotated and is substantially completely outside the periphery of the disks 102, 120′.

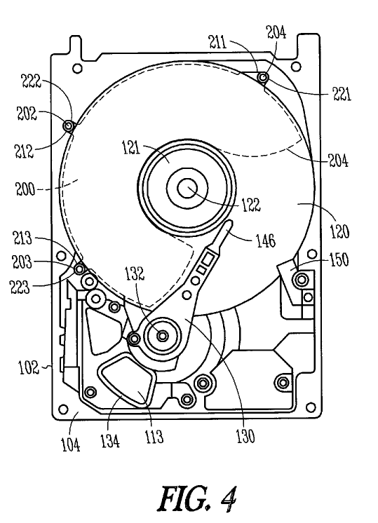

FIG. 3 is a perspective view of a disk drive after the turbulence reduction plate is placed between the disks, according to an example embodiment described herein. FIG. 4 is a top view of a disk drive after the turbulence reduction plate is placed between the disks, according to an example embodiment described herein. The turbulence reduction plate 200 is shown as hidden lines in FIG. 4. FIGS. 3 and 4 show an intermediate assembly associated with the disk drive 100. The intermediate assembly includes fastening the turbulence reduction plate 200 to the base 104 after placing the turbulence reduction plate 200 between the first disk 120 and the second disk 120′. This may also be referred to as merging the turbulence reduction plate 200 with the disk stack. The disk stack is the first disk 120, an intermediate spacer between the disks and the second disk 120′ as clamped to the spindle 122. Now referring to FIGS. 1-4, the intermediate assembly as well as the method of rotating the turbulence reduction plate 200 to a position between the disks 120, 120′ will be further detailed. As shown in FIGS. 3 and 4, the turbulence reduction plate 200 is positioned between the first disk 120 and the second disk 120′. All portions of the turbulence reduction plate 200 are within the footprint of the base 104 of the housing 102. The turbulence reduction plate 200 is also attached to the base 104 of the housing 102 at the mounting areas or mounting openings 211, 212, 213. Fasteners 221, 222, 223 pass through openings 201, 202, 203 in the turbulence reduction plate 200. The fasteners 221, 222, 223 then engage the mounting openings 211, 212, 213. In one embodiment, the fasteners 221, 222, 223 are threaded and engage threaded mounting openings 211, 212, 213. The turbulence reduction plate 200 has a thickness which is less than the space between the first disk 120 and the second disk 120′ as mounted on the spindle 122. The turbulence reduction plate 200 is positioned to leave a small space between the first disk 120 and the turbulence reduction plate 200, and to leave a small space between the second disk 120′ and the turbulence reduction plate 200. The spaces are small enough to substantially reduce or prevent turbulent flow of the air within the drive 100. The turbulence reduction plate 200 can be rotated on a pivot point 204 (shown in FIG. 4). In another embodiment, one of the fasteners 211 can be placed into threaded opening 201 to form a pivot point.

The turbulence reduction plate 200 is formed from a non magnetic material such as aluminum or industrial grade nylon. The turbulence reduction plate 200 is also grounded to the housing 102 so as to substantially prevent a buildup of a static charge on the turbulence reduction plate 200. As a result, this reduces or substantially eliminates an electrostatic discharge from occurring between the turbulence reduction plate 200 and one of the first disk 120 or the second disk 120′ or both.

FIG. 5 is a perspective view of a disk drive after the turbulence reduction plate 200 is placed between the disks 120, 120′ and with the cover 106 about to be installed, according to an example embodiment described herein. Attaching the cover 106 to the base 104 of the housing 102 encloses the disks 120, 120′ and the actuator 130 and the transducing heads 146 (there is generally one transducing head per major surface of the disk 120 and per major surface of the disk 120′). As can be seen, attaching the cover also includes enclosing the turbulence reduction plate 200 as well as the fasteners 221, 222, 223 and the mounting areas 211, 212, 213 associated with the housing 104. Attaching the cover 106 to the base 104 also is referred to as forming the head disk enclosure.

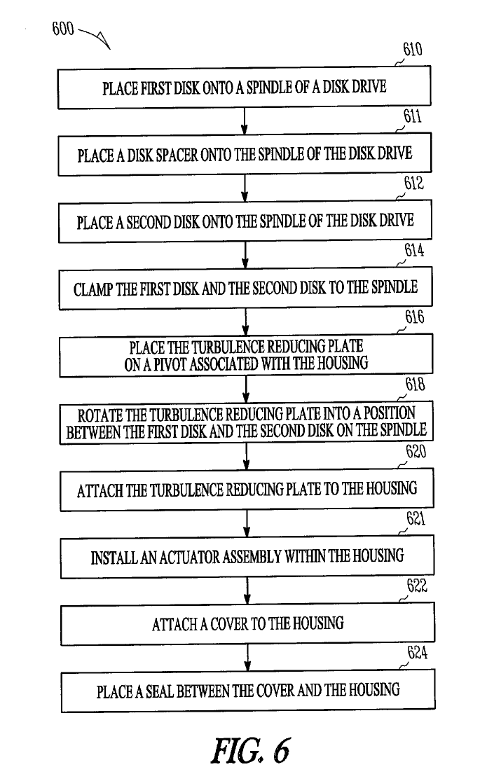

FIG. 6 is a flow chart of a method 600 for assembling a disk drive, according to an example embodiment. The method 600 for assembling a disk drive includes placing a first disk onto a spindle of a disk drive 610, placing a disk spacer onto the spindle of the disk drive 611, placing a second disk onto the spindle of the disk drive 612, and clamping the first disk and the second disk to the spindle 614. The second disk is spaced from the first disk. The method 600 also includes placing a turbulence reduction plate on a pivot associated with the housing 616, and rotating the turbulence reduction plate into a position between the first disk and the second disk on the spindle 618. The pivot is positioned outside the periphery of the first disk and second disk. The method also includes attaching the turbulence reduction plate to the housing 620, installing an actuator assembly within the housing 621, and attaching a cover to the housing 622.

FIG. 7 is a flow chart of a method 700 for assembling a disk drive, according to another example embodiment. The method 700 for assembling a disk drive includes placing disks and spacer on a spindle 710, and pivoting a turbulence reduction plate to a position between the disks on the spindle 712. Pivoting a turbulence reduction plate to a position between the disks on the spindle 712 includes placing the turbulence reduction plate on a pivot associated with the housing. In one embodiment, pivoting the turbulence reduction plate to a position between the disks on the spindle 712 includes partially attaching the turbulence plate to a mounting area of the housing for the disk drive. In another embodiment, pivoting the turbulence reduction plate to a position between the disks on the spindle 712 includes pivotally attaching the turbulence reduction plate to a first mounting opening of a housing for the disk drive. The method 700 further includes attaching the turbulence reduction plate to a second mounting opening of the housing 714. Attaching the turbulence reduction plate to a second mounting opening of the housing 714 also includes aligning an opening in the turbulence reduction plate with the second mounting opening, and placing a fastener through the opening in the turbulence plate and the second mounting opening. The method 700 may also include attaching the turbulence reduction plate to a housing for the disk drive 714 which includes placing fasteners through openings in the turbulence reduction plate and into corresponding mounting openings in the housing. The mounting openings of the housing are inside an outer periphery of the housing. The method also includes enclosing the disks and the turbulence reduction plate 718. This may include placing a cover onto the housing.

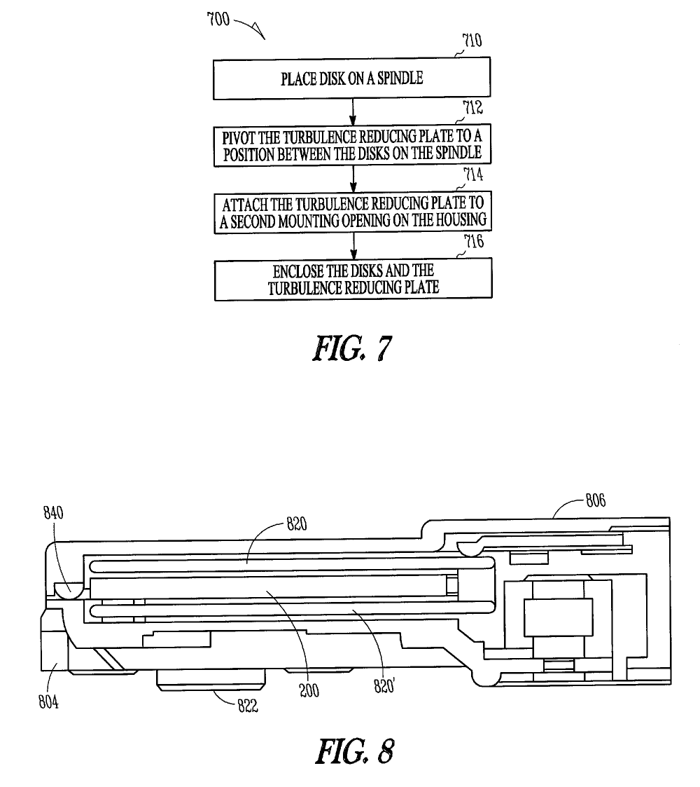

FIG. 8 is a partial cross section view of the assembled disk drive 800, according to an example embodiment. The disk drive 800 includes a base 804 of the housing 802, and a spindle 822 attached to the housing 802. A first disk 820 and a second disk 820′ are attached to the spindle 822. A set of mounting openings, one of which is shown as mounting opening 812, is placed in the housing near the periphery of where the first disk 820 and the second disk 820′ are attached to the spindle 822. The disk drive 800 also includes a turbulence reduction plate 200 positioned between the first disk 820 and the second disk 820′. The disk drive also includes a cover 806 attached to the housing. In one embodiment, the housing 804 and the cover 806 form a clam shell head disk enclosure. The housing 802 of the disk drive 800 includes a pivot attached to the housing 802, which, in one embodiment, is a fastener within a mounting area associated with the housing 802. The turbulence mounting plate 200 is shaped to rotate about the pivot to a position between the disks 820, 820′ without touching the first disk 820, the second disk 820′ or the spindle 822 during the rotation or at the final assembled position. A seal 840 is placed between the cover 806 and the base 804 of the housing 802. The seal 840 substantially seals the interface between the cover 806 and the base 804.

A printed circuit board (not shown) may be attached to the exterior of the chassis or housing base 804. The printed circuit board (PCB) may include four major electronic components, so-called system LSIs. The LSIs are mounted on the printed circuit board (PCB). The system LSIs are a head disk controller (HDC) 510, a read/write channel IC 520, a microprocessor unit (MPU) 530, and a motor driver IC 540. These control many aspects of the operation of the disk drive 800.

The MPU is a control unit of a driving system and includes a read only memory (ROM), random access memory (RAM), a central processing unit (CPU) 536, and a logic processing unit. Firmware (FW) for the logic processing circuit is saved to the ROM. Firmware includes a set of instructions executable by the MPU to control portions of the disk drive.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for assembling a disk drive comprising:
placing disks on a spindle; and
pivoting a turbulence reduction plate to a position between the disks on the spindle.

2. The method of claim 1 wherein pivoting a turbulence reduction plate to a position between the disks on the spindle includes placing the turbulence reduction plate on a pivot associated with the housing.

3. The method of claim 1 wherein pivoting a turbulence reduction plate to a position between the disks on the spindle includes partially attaching the turbulence plate to a mounting area of a housing for the disk drive.

4. The method of claim 1 wherein pivoting a turbulence reduction plate to a position between the disks on the spindle includes pivotally attaching the turbulence plate to a first mounting opening of a housing for the disk drive.

5. The method of claim 4 further comprising attaching the turbulence reduction plate to a second mounting opening of the housing.

6. The method of claim 5 wherein attaching the turbulence reduction plate to a second mounting opening of the housing includes;
aligning an opening in the turbulence reduction plate with the second mounting opening; and
placing a fastener through the opening in the turbulence plate and the second mounting opening.

7. The method of claim 1 further comprising attaching the turbulence reduction plate to a housing for the disk drive.

8. The method of claim 7 wherein attaching the turbulence plate to a housing for the disk drive includes placing fasteners through openings in the turbulence reduction plate and into corresponding mounting openings in the housing.

9. The method of claim 8 wherein the mounting openings of the housing are inside an outer periphery of the housing.

10. The method of claim 7 further comprising enclosing the disks and the turbulence reduction plate.

11. The method of claim 10 wherein enclosing the disks and the turbulence reduction plate includes placing a cover onto the housing.

12. A disk drive comprising:
a housing;
a spindle attached to the housing;
a first disk attached to the spindle;
a second disk attached to the spindle;
a set of mounting openings placed in the housing near the periphery of the first and second disks as attached to the spindle;
a pivot attached to the housing;
a turbulence reduction plate positioned between the first disk and the second disk, the turbulence reduction plate attached to the set of mounting openings, the turbulence reduction plate positioned on the pivot;
a cover attached to the housing.

13. The disk drive of claim 12 wherein the housing and the cover form a clam shell head disk enclosure.

14. The disk drive of claim 12 wherein the pivot is a fastener within a mounting area associated with the housing.

15. The disk drive of claim 12 wherein the turbulence mounting plate is shaped to rotate to a position between the disks without touching the first disk, the second disk or the spindle.

16. A method for assembling a disk drive comprising:
placing a first disk onto a spindle of a disk drive;
placing a second disk onto the spindle of the disk drive, the second disk spaced from the first disk;
clamping the first disk and the second disk to the spindle;
placing a turbulence reduction plate on a pivot associated with the housing;
rotating the turbulence reduction plate into a position between the first disk and the second disk on the spindle.

17. The method of claim 16 wherein the pivot is outside the periphery of the first disk and second disk.

18. The method of claim 16 further comprising;
attaching the turbulence reduction plate to the housing; and
attaching a cover to the housing.

19. The method of claim 18 further comprising placing a seal between the cover and the housing.
